(19) United States
(12) Patent Application Publication
(10) Pub. No.: US 2005/0029801 A1
(43) Pub. Date: Feb. 10, 2005

(54) Quick view pharmaceutical log

(76) Inventor: Deborah Jean Hinten, Leetonia, OH (US)

Correspondence Address: Rev. Deborah Jean Hinten M.S., 5701 Leetonia Road, Leetonia, OH, 44431, US

(21) Appl. No.: 10/662,113

(22) Filed: Aug. 6, 2003

(51) Int. Cl. B42D 15/00

(52) U.S. Cl. 283/115

(57) ABSTRACT

The present invention of an easily viewed and understood pharmaceutical chart will help determined with in minutes most of the medication's side effects, possible over medication problems, possible life threatening bothersome side effects, possible law suits and deaths. Subsequently, this present invention will avoid medication overdoses, unnecessary pain, out patient procedures, hospital stays, emotional trauma, not to exclude the intruding of quality of life and family disarray.

### BACKGROUND OF THE INVENTION

The present invention pertains to a quick reading of most side effects of most known drugs. The side effects of any two drugs could cause a synergic or compounded exponential effect of symptoms, baffling illnesses, medically foreseen explained illness or even death.

### PRIOR ART

Frequently many health care providers of any medical field are perplexed in helping their patients. The health care providers, themselves, know the composition and purpose of the specific drug. However, it is virtually impossible for any health care provider to memorize each side effect of each specific drug. Thus, the Physician Desk Reference may be their primary source of reference.

Being a novice in medical field, I have had to research many medications as questionable symptoms or side effects arise. In having the side effect information but no chart of any form, I had to develop my own system of comparing and contrasting all possible side effects from all the prescribed medications. Needless to say, as a result, it is undetermined if this research is just revealing the side effects of the medications or a new illness.

Thus, this present invention or pharmaceutical log is based upon The Pill Book published by CMD Publishing; A Division Of Current Medical Direction and edited by Harold M. Silverman, Pharm. D. This book has been recommended by various nurses and the local librarian. Plus, it is the laymen's version of the Physician's Desk Reference.

The Pill Book, itself, lists the side effects of each named drug in order of frequency of occurrence. Since each person's electrical and chemical system is different, a rare side effect of one medication may develop into a crucial problem in certain individuals. Where on the other hand, another individual may experience no side effects at all.

As the result, many times, more medication is be prescribed to contract all these symptons. Where on the other hand, the medication's side effect, itself, may cause the hidden illness. This issue might be simply solved with a change of medication. To my knowledge, there is no tool available to compare and contrast most side effects of each medication.

Eventhough one might consider two medications listed having the same side effects, does not mean it will agree or disagree with that particular individual. Therefore one must be willing to try various types of medications and brand names to find the best medication for that particular individual. However, one must consult with their primary care giver or pharmacist before doing so. Since according to The Pill Book, various similar medications or various brand names may conflict with various other previous prescribed meditations.

Without considering the present invention, all the side effects from the various medications could only compound the problem. Thusly, additional side effects may have become the issues and the problem may become worse than the primary problem.

I personally know of numerous cases where death may have been avoided. I, myself, a novice without any medical education had to become a legal medical advocate for my parents. In the process, I am learning that many prescribed medications left unchecked could develop into many fatal illnesses. Subsequently a wrongful death legal action could seldom be won.

Being an ordained minister, I am willing to stand with and for my people through the very end of their live's. As I personally beseech for their lives through prayer, many times simple solutions are revealed.

The following case concerns one of my parents and no longer needs an immediate action. Since we have an excellent internist, Lovina' condition has improved immensely. However, legal and medical issues are still conflicting. Lovina, my mother, is legally blind. Plus, she has chronic bronchiectasis, asthma, sugar diabetes and still does have an edema problem or still is retaining water.

For many years of consulting many specialists, most if not all of the physicians have suggested that our family doctor should be able to take care of the edema problem. It has been over four years now and still Lovina is suffering with the same problem. Now she has an internal specialist which is now helping to solve the problem. Since Lovina definitely needs a diuretic, hopefully the internist will simply change to another medication. However if my suspicion is correct, some of these medical problems could have been controlled or completely avoided.

Approximately a year before the first lung tap, a family physician gave her a few weeks to live. At that time, she was prescribed at least twelve different kinds of medications. These medications did not include the sodium breathing treatment nor asmacort, which is an inhalator.

To make life more complex, the sodium treatments gave Lovina an unbearable sore throat which made swallowing or eating painful. This does not include Parkinson's Disease like symptoms. With all these life threatening symptoms, the doctor still refused to consider changing medications or deny the the side effects of the medication. At this point, I started to become a medical researcher, myself.

To this date, Lovina's lungs has been tapped twice. The last time was around Mar. 22, 2001.

Thusly, if my suspicions are correct, the side effects of Lovina's medications were creating more damage than potential good. Lovina is now progressing beautifully under an internist care which is rapidly changing or eliminating unnecessary medications.

The current dilemma concerns the prescribed drug, demadex. Demadex is a water pill or diuretic which effects almost every organ in your body. It specifically dries up the water in the colla ear canal. This would harm anyone's hearing! However, Lovina is legally blind with continual failing eye sight. When several specialists were mildly questioned about Lovina's hearing problems, no one thought any of the medication's side effect would bother her. However, according to The Pill Book and twenty-four hour continual observation, Lovina can hear much better without this drug. According to a local pharmacist, there are numerous other drug combinations which do not have the lost of hearing side effects. Considering that he was a pharmacist and not Lovina's physician, he could make some unauthorized recommendations. The primary care physician would have to make the final approval. The reliable pharmacist shared that many physicians no longer consult the Physician's Desk Reference.

To make life more complicated, the pharmacists are now obeying the law and supplying each patient with a computerized list of symptoms. Ironically, most of the drug's common symptoms are verified by the Physician's Desk Reference or The Pill Book. Unfortunately, this law means nothing at all if the physician ignores the patient's side effect concerns, symptoms or does not use the Physician's Desk Reference as primary informational source or as a cross reference. Therefore to my knowledge, there is no quick pharmaceutical log of side effect charting to compare and contrast drugs.

Fortunately, Lovina's excellent internist consulted the Physician's Desk Reference and figured out the delicate water balance within Lovina's system. Currently, Lovina is taking approximately one-fourth of the previous prescribed amount of demadex. As a result, Lovina's hearing has been restored!

The previous heath care provider refused to consider my plea and recommended hearing aids. The hearing aides would not be cover by Lovina's insurance but an out of pocket $2,000.00 expense. This four year hearing lost could have been settled by reducing or changing Lovina's diuretic.

On the other hand, many specialists document all Lovina's medications but do not chart their side effects. Thusly, hearing lost, blurred vision and other impairments can and is caused by uncharted medication side effects.

As a result, the patient or the insurance is paying for unnecessary or wrongly prescribed hearing aides, glasses and/or prescriptions. Any doctor of any kind should have a standardize pharmaceutical guide of documented side effects. These will reveal potential problem areas within seconds. Having this pharmaceutical quick view log will avoid many misdiagnosis, save costs, frustration, and lifes!

Consequently, as I charted Lovina's medication, anyone will notice an obvious potential dangerous pattern emerging. Thus, an increased disability caused by the medication's side effects almost prohibited me from taking care for her at home or even could have caused her premature my death if it was caught in time.

Please consider the practical application of such value charted information which is already provide in the Physician's Desk Reference.

Enclosed are the standard forms which present the drug's most common side effects. This form should be enclosed with all medications at the expense of each responsible drug company. Thusly, allowing anyone to compare and contrast their medication. Plus, this drug company information needs to be in a standardized sixteen point computerized sized print. This standized sixteen sized print will help most people from misreading the label especially when ill, elderly or in an emergency. This standardized sixteen point print may seem to be extreme. However, please realize many illnesses and/or medications could temporary impair the reader's vision. This action will be cost effective in saving lives immediately.

| | | | | | | | | | | | | |
|---|---|---|---|---|---|---|---|---|---|---|---|---|
| MUSCULAR-SKELETAL DISORDERS | | | | | | | | | | | | |
| Arthritis | | | | | | | | | | | | |
| Joint pain | | | | | | | | | | | | |
| Leg cramps | | | | | | | | | | | | |
| THE FIVE SENSES | | | | | | | | | | | | |
| Loss of appetite | | | | | | | | | | | | |
| Loss of taste/change of taste | | | | | | | | | | | | |
| Retina degeneration/eye changes | | | | | | | | | | | | |
| Drying or burning eyes | | | | | | | | | | | | |
| Ear problems | | | | | | | | | | | | |
| Loss of hearing | | | | | | | | | | | | |
| Nosebleeds | | | | | | | | | | | | |
| Loss of smell | | | | | | | | | | | | |
| Tingling of toes and fingers | | | | | | | | | | | | |
| Cool body temperature | | | | | | | | | | | | |
| Hot flashes, hot body temp. | | | | | | | | | | | | |
| Rash | | | | | | | | | | | | |
| Skin disorders | | | | | | | | | | | | |
| Cold and clammy sin | | | | | | | | | | | | |
| Discolored or yellow/gray/blue | | | | | | | | | | | | |
| Dry skin | | | | | | | | | | | | |
| Unusual bruising | | | | | | | | | | | | |
| Sensitive to sunlight | | | | | | | | | | | | |
| RESPIRATORY DISORDERS (CHEST) | | | | | | | | | | | | |
| Coughing | | | | | | | | | | | | |
| Causes asthma | | | | | | | | | | | | |
| Relieves asthma | | | | | | | | | | | | |
| Shortness of breath | | | | | | | | | | | | |
| Breathing difficulty | | | | | | | | | | | | |
| Wheezing | | | | | | | | | | | | |
| Causes bronchitis | | | | | | | | | | | | |
| Fluid in lungs | | | | | | | | | | | | |
| RESPIRATORY DISORDERS (NOSE) | | | | | | | | | | | | |
| Sore throat | | | | | | | | | | | | |
| Allergies | | | | | | | | | | | | |
| Runny nose | | | | | | | | | | | | |
| Sinus problems | | | | | | | | | | | | |
| SEXUAL DISFUNCTION | | | | | | | | | | | | |
| Female problems | | | | | | | | | | | | |
| Male problems | | | | | | | | | | | | |
| Sexual intercourse | | | | | | | | | | | | |
| DRUG RELATED WARNING | | | | | | | | | | | | |
| MENTAL DISORDERS | | | | | | | | | | | | |
| Depression | | | | | | | | | | | | |
| Moody | | | | | | | | | | | | |
| Mental confusion | | | | | | | | | | | | |
| Memory loss | | | | | | | | | | | | |
| Paranoia | | | | | | | | | | | | |
| Psychosis | | | | | | | | | | | | |
| Delirium | | | | | | | | | | | | |
| Hallucinations | | | | | | | | | | | | |
| Sleeping disorders | | | | | | | | | | | | |
| PLEASE ALWAYS CONSULT THE P.D.R. | X | X | X | X | X | X | X | X | X | X | X | X |
| OR THE PILL BOOK CONCERNING THIS | | | | | | | | | | | | |
| DRUG AT ALL TIMES | | | | | | | | | | | | |
| BODY AS A WHOLE | | | | | | | | | | | | |
| Loss of consciouseness | | | | | | | | | | | | |
| Headache | | | | | | | | | | | | |
| Pain | | | | | | | | | | | | |
| Flue-like symptoms | | | | | | | | | | | | |
| Fatigue | | | | | | | | | | | | |
| Weakness | | | | | | | | | | | | |
| Back Pain | | | | | | | | | | | | |
| Chest Pain | | | | | | | | | | | | |
| Hair loss | | | | | | | | | | | | |
| Blood Sugar elevation | | | | | | | | | | | | |
| Lower blood sugar | | | | | | | | | | | | |
| Sweling of ankles, feet, legs | | | | | | | | | | | | |
| Swelling of breast | | | | | | | | | | | | |
| Weight gain | | | | | | | | | | | | |
| Weight loss | | | | | | | | | | | | |
| Dehydrated | | | | | | | | | | | | |
| Weakened the immune systems | | | | | | | | | | | | |
| Reduces white blood cells | | | | | | | | | | | | |
| Reduces red blood cells | | | | | | | | | | | | |
| Reduces blood volume/platelets | | | | | | | | | | | | |
| Thins the blood | | | | | | | | | | | | |
| Lowers blood potassium | | | | | | | | | | | | |
| High blood potassium | | | | | | | | | | | | |
| POTASSIUM WARNING | | | | | | | | | | | | |
| CARDIOVASCULAR DISORDERS | | | | | | | | | | | | |
| Hypertension | | | | | | | | | | | | |
| Lowers blood pressure | | | | | | | | | | | | |
| Abnormal heart rate | | | | | | | | | | | | |
| Rapid heart rate/palpitations | | | | | | | | | | | | |
| Reduced heart rate | | | | | | | | | | | | |
| Heart attack/problems/disease | | | | | | | | | | | | |
| Reduces heart failure | | | | | | | | | | | | |
| Blood vessel problems | | | | | | | | | | | | |
| CENTRAL & PERIPHERAL NERVOUS | | | | | | | | | | | | |
| Dizziness | | | | | | | | | | | | |
| Drowsiness | | | | | | | | | | | | |
| Insomnia | | | | | | | | | | | | |
| Nervousness/restlessness | | | | | | | | | | | | |
| Spasms/spasticity/tremors | | | | | | | | | | | | |
| GASTROINTESTINAL DISORDERS | | | | | | | | | | | | |
| Dry mouth | | | | | | | | | | | | |
| Various mouth disorders | | | | | | | | | | | | |
| Reduces esophagus disorders | | | | | | | | | | | | |
| Nausea | | | | | | | | | | | | |
| Vomiting | | | | | | | | | | | | |
| Raises gallbladder problems | | | | | | | | | | | | |
| Reduces gallbladder problems | | | | | | | | | | | | |
| Constipation | | | | | | | | | | | | |
| Diarrhea | | | | | | | | | | | | |
| Abdominal pain | | | | | | | | | | | | |
| Bile ulcers | | | | | | | | | | | | |
| Stomach gas | | | | | | | | | | | | |
| Burning stomach | | | | | | | | | | | | |
| Bleeding ulcers | | | | | | | | | | | | |
| Urinary difficulty | | | | | | | | | | | | |
| Urinary infection | | | | | | | | | | | | |
| Frequent urination | | | | | | | | | | | | |
| Nonfunctioning kidneys | | | | | | | | | | | | |
| Liver disease | | | | | | | | | | | | |

1. The present invention comprises of the following two concepts:
(a) a quick viewed pharmaceutical log which displays most possible side effects in an easy and understandable chart for everyone, care gives and novices alike
(b) and it will help determine any possible over medication problems, life threatening bothersome side effects, possible law suits and deaths.
